(19) United States
(12) Patent Application Publication
(10) Pub. No.: US 2024/0361206 A1
(43) Pub. Date: Oct. 31, 2024

(54) METHOD FOR DETECTING A BEARING DEFECT IN A ROTATING SYSTEM AND MONITORING SYSTEM IMPLEMENTING THIS METHOD

(71) Applicant: SAFRAN, PARIS (FR)

(72) Inventors: Amadou ASSOUMANE, MOISSY CRAMAYEL (FR); Dany ABBOUD, MOISSY CRAMAYEL (FR); Mohammed EL BADAOUI, MOISSY CRAMAYEL (FR); Yosra MARNISSI, MOISSY CRAMAYEL (FR)

(21) Appl. No.: 18/682,706

(22) PCT Filed: Aug. 9, 2022
(86) PCT No.: PCT/FR2022/051573

§ 371 Date: Feb. 9, 2024

(30) Foreign Application Priority Data
Aug. 11, 2021 (FR) FR2108632

(51) Int. Cl. G01M 13/045

(52) U.S. Cl. CPC G01M 13/045

(57) ABSTRACT

A method for detecting a defect in a bearing of a rotating system, includes acquiring a bearing position signal, a vibratory signal from the bearing and a theoretical characteristic vector of the bearing; determining a deterministic part of the vibratory signal and removing the deterministic part to obtain a residual signal function of the position signal; calculating, from the theoretical characteristic vector, lower and upper bounds of defect frequencies; calculating, from the vibratory signal, a spectral coherence and the square of the amplitude of the spectral coherence; calculating, from the square of the amplitude of the spectral coherence and the lower and upper bounds of the defect frequencies, a current characteristic vector of the bearing; determining a spectral cyclic contrast of the defect; finely identifying signatures of interest by calculating a weighted integrated cyclic coherence associated with the defect, and determining diagnostic indicators easily interpretable by an operator.

### TECHNICAL SCOPE OF THE INVENTION

This invention relates to a method for detecting a defect in a bearing of a rotating system, such as a bearing of an aeronautical turbomachine.

The invention finds applications in the field of monitoring wear on bearings such as wind turbine or car engine or motor bearings. In particular, it has applications in the aerospace industry for monitoring bearings of turbomachine rotating systems.

### TECHNOLOGICAL BACKGROUND OF THE INVENTION

In industry, and especially in aeronautics, bearings, such as ball or roller bearings, are often subject to specific monitoring in order to detect any damage or wear at an early stage. Bearings are some of the most highly stressed and critical mechanical components in a wide range of equipment, such as turbojet engines, compressors, thrust reversers, etc. Premature wear or unexpected failure of a bearing can affect the operational safety of equipment and, in some cases, even the safety of users. It is therefore necessary to monitor the health condition of complex equipment comprising several rotating elements (combustion rods, bearings, gears, fans, etc.) and in particular the health condition of bearings in order to detect the appearance of a defect or damage as early as possible.

Generally speaking, the operation of a defective bearing, especially in aircraft engines and gearboxes, is characterised by a pulse signal. However, this pulse signal is often masked by the presence of a multitude of noise-generating sources, resulting in a very low signal-to-noise ratio. In the example of an aircraft, the vibratory signals are heavily dominated by aerodynamic noise and thus by interference generated by other rotating parts of the aircraft such as compressors, fans, turbines, gears, etc. This interference makes it difficult to detect a bearing defect from its vibratory signals.

As the detection of bearing defects is a critical issue, many methods have been contemplated or designed to try and detect any defects or damage to bearings as effectively as possible. Several patent documents provide different detection techniques. In particular, patent document EP1970691 A1 provides a method for detecting damage to a bearing supporting at least one rotation shaft of an engine, wherein a measurement period corresponding to a range of shaft rotation speeds during a renewable activity at low engine operating speed is defined. The method then consists in acquiring, over the entire measurement period, a vibratory acceleration signal, then sampling the vibratory signal as a function of the speed of rotation of the motor during the measurement period, then transforming the sampled vibratory signal into a frequency signal in order to obtain spectral frequency lines ordered as a function of the speed of rotation of the shaft, then averaging the amplitudes of the spectral lines, determining amplitude peaks around multiples of the theoretical frequency of a damaged roller, calculating the ratio between each amplitude peak and the completed amplitude level for a healthy bearing, and comparing the ratio obtained with at least one predetermined damage threshold. This method has the drawback of being based on an analysis of the signal spectrum. However, it is well known in the literature that a simple analysis of the signal spectrum is not a suitable approach for detecting a bearing defect, in particular when the signal-to-noise ratio is very low, as is the case in the aerospace industry.

Patent document CN 106771598 A describes a method for detecting bearing defects wherein a mechanical vibratory signal from engine components is acquired over a measurement period P of variation in shaft speed N. The method then consists in sampling the signal during the period P, then synchronising the signal with changes in speed N, converting the signal into a frequency signal to obtain spectral frequency lines ordered according to speed N, calculating the average of the amplitudes of the spectral lines in order to obtain a current vibration signature of the engine, calculating a deviation rate between the signature and a reference sound vibration signature and comparing the deviation rate with defect pointers in a pre-established database listing theoretical damage to the engine's bearings in order to determine potential damage to said bearings. However, as with the previous method, this method is based on signal spectrum analysis, which is bound to fail, especially in very noisy environments.

Patent document EP 2693176 A1 describes a method for detecting defects in a bearing by vibration analysis. The method is based on signal pre-processing followed by envelope analysis. The aim of this pre-processing is to separate the deterministic part from the random part and to improve impulsivity of the signal. Once the envelope spectrum is calculated, a probabilistic approach is used to solve the defect frequency deviation problem. Thus, indicators based on the sum of the amplitudes of the harmonics of the defect frequency in the envelope are provided as diagnostic indicators. However, pre-processing techniques have a high computing cost and depend significantly on the parameters defined as input parameters.

Patent document CN 104236908 B describes a method for detecting defects in a bearing by vibration analysis. This method is based on a cyclostationary analysis of the vibratory signal using the modulation intensity distribution. The drawback of this method is that it requires a matrix to be calculated before defect descriptors can be extracted. It also has the drawback of not dealing with the problem of defect frequency deviation.

Patent document EP 1970691 A1 also describes a method for detecting defects in a bearing by vibration analysis. This method consists in calculating the spectrogram output. In particular, the frequency variable in the spectrogram is replaced by the order of the rotation shaft carried by the bearing being monitored. The average with respect to time is then calculated and the defect frequencies (and their multiples) are compared with reference cases wherein the bearings are healthy. Since the diagnostic information is obtained by spectral analysis to order 1, the effectiveness is limited to well-defined applications.

Patent document CN 105092249 A describes a method for detecting bearing defects using vibration analysis. The method involves designing a Gabor filter whose parameters (centre frequency and bandwidth) are optimised to maximise the norm index of the filtered signal. The envelope autocorrelation spectrum is then calculated on the filtered signal. The diagnostic information can be found in this distribution. The drawback of this method, which is based on envelope analysis after pre-processing of the vibratory signal, is that it is costly, especially because of the pre-processing. It also has the drawback of not dealing with the problem of deviation from the characteristic frequency.

Patent document CN 104655423 A describes a method for detecting bearing defects by vibration analysis. This method is based on a fusion of defect descriptors in the time-frequency domain. It involves calculating the time-frequency distribution for healthy cases and cases containing different types of defect. Redundancy between the distributions is eliminated and only the distinctive descriptors that enable an operator to make a judgement are retained. However, this method requires a database containing all the types of defect, which is rarely available within the scope of aeronautics. Furthermore, this method involves a high calculation cost.

Patent document CN 106771598 A describes a method for detecting bearing defects using cyclostationary analysis. This method uses cyclic coherence and its integrated version to extract indicators consisting of the sum of the harmonics of the defect. The drawback of this method is the relatively low detectability of defects with a very low signal-to-noise ratio in the case of aeronautical vibratory signals.

Several practical difficulties call into question the effectiveness of market monitoring methods. Conventional methods based on spectral analysis or envelope analysis are often unable to detect defects with weak signatures, i.e. low signal-to-noise ratios. This leads to defect detection failure or, at best, late detection of the defect. Other, more efficient methods are based on source separation techniques. However, these methods are particularly time-consuming to compute, resulting in high computation costs that cannot be achieved in real time. Other methods use sophisticated cyclostationary methods to perform detection when the defect signature is low. However, these methods do not take into account possible bearing slippage and the fact that damage is often accompanied by friction, which tends to slow down the rotation of the damaged element; they therefore do not take into account the fact that actual defect frequencies may differ from the theoretical values calculated.

There is therefore a real need for a method which can detect bearing defects when the signal-to-noise ratio is low and which takes into account the potential phenomena of bearing sliding and friction.

### SUMMARY OF THE INVENTION

In response to the problems discussed above of detecting bearing defects when the signal-to-noise ratio is low, the applicant provides a method for detecting a bearing defect in a very noisy environment, based on advanced cyclostationary analysis of the vibratory signal captured by one or more accelerometers. This method provides for de-noising the signal, estimating the actual frequencies of the bearing defect, analysing the signal using cyclostationary analysis designed to obtain the defect signature even when the signal-to-noise ratio is small, and calculating diagnostic indicators giving information about the health condition of the bearing.

According to a first aspect, the invention relates to a method for detecting a defect in a bearing of a rotating system, including the following steps:
Acquiring a bearing position signal, a bearing vibratory signal and a theoretical characteristic vector for the bearing;
Determining a deterministic part of the vibratory signal and removing said deterministic part to obtain a residual signal which is a function of the position signal;
Calculating upper and lower bounds of defect frequencies from the theoretical characteristic vector;
Calculating spectral coherence and the square of the amplitude of the spectral coherence from the vibratory signal;
Calculating, from the square of the amplitude of the spectral coherence and the lower and upper bounds of the defect frequencies, a current characteristic vector of the bearing;
Determining the spectral cyclic contrast of the defect;
Finely identifying signatures of interest by calculating a weighted integrated cyclic coherence associated with the defect;
Determining diagnostic indicators easily interpretable by an operator.

This method has the advantage of detecting very weak signatures, i.e. with a very low signal-to-noise ratio, so as to take account of aerodynamic and mechanical interference related to the bearing environment. This method also has the advantage of being highly automated and requiring little user intervention.

In the description, “defect” means any damage or wear to one or more elements of a bearing such as a ball bearing or roller bearing.

Furthermore, “signature” noted as [symbol] (α_{d}, αₘ), refers to the set of frequencies generated by the vibratory signal and revealed by the application of some transforms to the vibratory signal, such as the Fourier transform, the envelope spectrum, spectral correlation, etc.

Further to the characteristics just discussed in the previous paragraph, the method for detecting a bearing defect according to one aspect of the invention may have one or more additional characteristics from among the following, considered individually or according to any technically possible combinations:
the defects include four types of defect, with defect frequencies and defect signatures determined for each type of defect.
The four types of defect are: an outer race defect, an inner race defect, a rolling element defect and a cage defect.
step e) includes estimating, for each type of defect, a current defect frequency corresponding to the most probable frequency between the lower bound and the upper bound.

step f) includes, for each type of defect, determining a contrast of the defect signature and then applying this contrast to the square of the amplitude of the spectral coherence.
step g) includes, for each type of defect, determining a weight associated with said defect and then calculating a weighted integrated cyclic consistency for said defect.
the diagnostic indicators include, for each type of defect, a contrast of the signature of interest in the weighted integrated cyclic coherence, a contrast of the signature of interest in an envelope spectrum of the residual signal and a relevance indicator of the signature of interest.
the diagnostic indicators are each quantified by means of a value, said value being close to zero in the absence of a defect.
step c) is carried out before step b), after step d) or simultaneously with step b) or d), the lower and upper bounds being input data for step e).

According to another aspect, the invention relates to a system for monitoring

the health condition of an aircraft, characterised in that it includes a device implementing the method as defined previously.

### BRIEF DESCRIPTION OF THE FIGURES

Other advantages and characteristics of the invention will become apparent upon reading the following description, illustrated by the figures in which:

FIG. 1 represents, in the form of a function diagram, an example of the different operations of the method for detecting a bearing defect according to the invention;

FIG. 2 represents a schematic cross-section view of an example of a bearing and its geometric characteristics;

FIG. 3 represents examples of raw, deterministic and random signals obtained by a first operation of the method of FIG. 1;

FIG. 4 represents an example of a signal obtained by a spectral coherence calculation operation in the method of FIG. 1;

FIG. 5 represents examples of signals obtained by an operation to determine spectral cyclic contrasts in the method of FIG. 1;

FIG. 6 represents examples of signals obtained by an operation for calculating the spectral coherence, integrated and integrated and weighted respectively, of the method of FIG. 1;

FIG. 7 represents examples of signals being diagnostic indicators obtained at the end of the method of FIG. 1 for four types of defect.

### DETAILED DESCRIPTION

An exemplary embodiment of a method for detecting a bearing defect, applicable in a very noisy environment, is described in detail below, with reference to the appended drawings. This example illustrates the characteristics and advantages of the invention. However, the invention is not limited to this example.

In the figures, identical elements are identified by identical references. For reasons of legibility, the size scales between the elements represented are not respected.

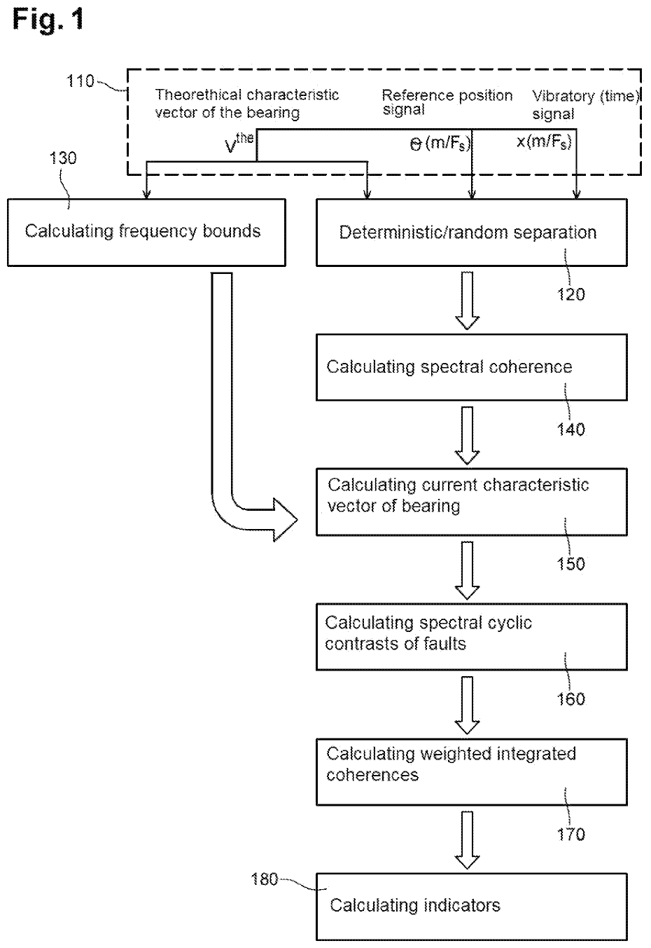

The method 100 for detecting defects in a bearing according to the invention includes seven operations or stages, referenced 120 to 180 in FIG. 1. It further includes a preliminary operation 110 of acquiring input data for the method. This input data, acquired either by measurements using one or more sensors (under constant or variable operating conditions), or by theoretical calculations, includes a position signal of the bearing relative to the rotation shaft of the rotating system in which the bearing is mounted, a vibratory signal of the bearing and a theoretical characteristic vector of said bearing. The position signal is a signal coming, for example, from a position sensor, such as an encoder or a tachometer, and carrying information on the angular position of the reference shaft, from which the position of the bearing shaft can be deduced.

The measurement sensors may be, for example, a position sensor, an accelerometer, a microphone, a strain gauge, a laser micrometer and/or any other vibratory or acoustic sensor. In one embodiment, an accelerometer is mounted on a fixed part of the rotating system and a position sensor is installed in proximity to a reference axis of said rotating system to measure the rotation of said system. Vibration signals and position signals can thus be acquired by these sensor and accelerometer, over a quasi-stationary speed range. They can be saved in digital form, for example in a database, before being transmitted to a data processing device, such as a computer, whether or not on board the aircraft.

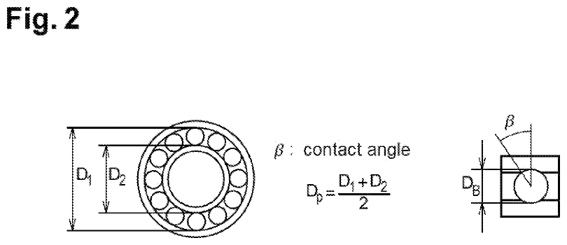

The kinematics of the bearing, i.e. the theoretical characteristic vector of said bearing, can be calculated theoretically from the geometric dimensions of the bearing. An example of the different dimensions and characteristics of a bearing, required to implement the method of the invention, is represented in FIG. 2. As a reminder, a bearing includes an inner race and an outer race, which are coaxial, between which rolling elements (generally balls or rollers) rotate, spaced apart by a cage. In the remainder of the description, balls, rollers or rotary elements will be used interchangeably, it being understood that these are rotating elements housed between the two coaxial rings. In the example of FIG. 2, the pitch diameter of the bearing, i.e. the average diameter between the diameter of the outer race and the diameter of the inner race, is called Dₚ; the diameter of a ball or rolling element inside the bearing is called D_{B}; the contact angle of the rolling elements, i.e. the angle between the axis of rotation of the rolling elements and the axis of the rotation shaft, is called β; the number of rolling elements (e.g. balls) is called N_{B}. The kinematics of the bearing is defined by four theoretical characteristic frequencies:
The outer race defect frequency (“Ball-Pass Frequency on the Outer Race Frequency: BPFO^{the}”);
The inner race defect frequency (“Ball-Pass Frequency on the Inner race frequency: BPFI^{the}”);
The ball defect frequency (Ball Spin Frequency (BSF^{the}); and
The cage defect frequency (“Failure Train Frequency: FTF^{the}”), the cage being the housing or envelope of the bearing in which the rolling elements run.

If SRF is the rotational frequency of the bearing shaft (Shaft Rotation Frequency), considered as the reference shaft, and if SRF is expressed in number of events per revolution (evt/rev), then the theoretical characteristic frequencies of a bearing, which define the theoretical characteristic vector of the bearing, can be calculated as follows:
Outer race failure frequency:

$$BPFO = \frac{{N}_{B}}{2} ( 1 - \frac{{D}_{B}}{{D}_{P}} cos β ) SRF$$

Inner race failure frequency:

$${BPFI}^{the} = \frac{{N}_{B}}{2} ( 1 + \frac{{D}_{B}}{{D}_{P}} cos β ) SRF$$

Ball defect frequency:

$${BSF}^{the} = \frac{{D}_{P}}{{D}_{B}} ( 1 - {( \frac{{D}_{B}}{{D}_{P}} cos β )}^{2} ) SRF$$

Cage defect frequency:

$${FTF}^{the} = \frac{1}{2} ( 1 - \frac{{D}_{B}}{{D}_{P}} cos β ) SRF$$

Step 120: After acquiring the input data in step 110, the detection method 100 includes an operation 120 of separating the deterministic part of the vibratory signal previously acquired, i.e. for determining and removing this deterministic part in order to obtain a residual signal. In this step, also called operation, and in the rest of the method, the vibratory signal, which is a time signal, will be noted x[n]; the position signal will be noted θ[n]; the theoretical characteristic vector of the bearing, whose components are BPFO^{the}, BPFI^{the}, BSF^{the}, FTF^{the}, SRF, will be noted V^{the}.

The operation 120 of separating the deterministic part of the vibratory signal consists of determining and then eliminating the deterministic part of said vibratory signal. The vibratory signal from a defective bearing, which is of a random cyclostationary nature characterised by a hidden periodicity related to the defect, may be masked by deterministic signals generated by vibratory phenomena unrelated to bearing defects (for example a gear defect, shaft misalignment and imbalance, etc.). In order to establish an accurate diagnosis, it is important to eliminate any deterministic signals that may be generated by these vibratory phenomena unrelated to bearing defects, so that they do not mask the signature of the bearing defect and, consequently, distort the diagnosis.

It should be noted that the time signal x[n] is transformed into the angular domain using the position signal θ[n], to obtain the angular signal x[θ]. This process is known to those skilled in the art as angular resampling. As the signal x[θ] is a digital signal, it is chosen to replace θ by n; this gives x[n]. The residual signal is then calculated by filtering the signal x[n] using the filter hᵢ as defined below. The result of this convolution gives rise to the residual signal r[n], with: r[n]=Σᵢ₌₀^{L-1}r[n−i]hᵢ. In the vast majority of applications, the speed of rotation of the rotating system may fluctuate or vary. It is therefore chosen to define periodicity of the deterministic part of the vibratory signal in terms of angle rather than time. To do this, the vibratory signal, acquired in the form of a time signal, is resampled in angle using the position signal, or a speed signal measured for example by a sensor facility on one of the reference shafts of the rotating system. The notion of frequency will then be replaced by the notion of order. The order expresses the number of events per revolution of the reference shaft and its unit is noted by [evt/rev]. For example, the order 2 of a component is equivalent to twice the rotation frequency of the reference shaft. The resampled signal is expressed digitally over angular instants equally spaced by the angular resolution Δθ=Θ_{ref}/Nᵣₑᵥ where θ_{ref} denotes a complete angular rotation of the reference shaft and Nᵣₑᵥ the number of points per reference revolution. To avoid folding, the following condition must be satisfied: Nᵣₑᵥ=ceil(Fₛ/min(f_{ref}(t) where ceil is the content rounding function to the larger integer, f_{ref}(t) is the instantaneous rotation frequency of the reference shaft and Fₛ is the sampling frequency. After resampling, the vibratory signal xᵢ becomes xᵢ=x(iΔθ) and is the vibratory signal in the angular domain defined over N samples.

In the method described in the invention, an unsupervised method is applied which enables all rotating systems to be monitored, especially complex rotating systems in which the kinematics of all the rotating components is not necessarily available. To achieve this, it is provided to apply the frequency version of the SANC method, also known as “frequency domain noise cancellation”. The principle of the SANC method, and its frequency domain version, are known and explained in the following document, incorporated here by reference: Antoni, R. B. Randall, Unsupervised noise cancellation for vibratory signals: part II—A novel frequency-domain algorithm, Mechanical Systems and Signal Processing, Volume 18, Issue 1, 2004, Pages 103-11. This SANC method consists in finding a predictor \hat{x}[n] of the signal x[n] using a finite number of past instants [n−Δ−i], i=0 . . . N_{f}−1 with N_{f} the length of the filter and Δ such that Rₓₓ[m]=E{r[n]r[n−m]}=0 for all |m|>Δ. The optimal solution to this problem is given by the following linear regression (equivalent to time-invariant linear filtering) where hi denotes the ith coefficient of the filter:

$$\hat{p} [ n ] = \hat{x} [ n ] = {\sum }_{i = 0}^{{N}_{f} - 1} {h}_{i} x [ n - Δ - i ]$$

The random part can be deduced as follows:

$$\hat{r} [ n ] = x [ n ] - \hat{x} [ n ] = x [ n ] - \hat{p} [ n ]$$

The filter coefficients are estimated so as to minimise the square error. A good estimator of this filter in the frequency domain is then given by the following equation:

$$\overline{H} ( f ) = \frac{{\sum }_{k = 1}^{K} {X}_{k}^{d} ( f ) {{X}_{k} ( f )}^{*}}{{\sum }_{k = 1}^{K} {X}_{k}^{d} ( f ) {{X}_{k}^{d} ( f )}^{*}}$$

Where Xₖ(f) and Xₖ^{d}(f) are the discrete Fourier transforms of xₖ[n] and of xₖ^{d}[n] calculated on M≥N_{f}, xₖ[n]=x[n+kT]. w_{N}[n] where w_{N}[n] is a weighting window of size N and where xₖ^{d}[n]=x[n+kT−Δ]. w_{N}[n]. The temporal filter can be obtained by applying the inverse discrete Fourier transform to M points. The temporal filter obtained is as follows:

$${h}_{i} = {\int }_{- {F}_{s} / 2}^{{F}_{s} / 2} \hat{H} ( f ) {e}^{j 2 π if / Fs} df$$

Note that the effective length of the filter is N_{f} and not M, and that the latter is used to speed up calculations (especially through the Fast Fourier Transform (FFT) algorithm).

As can be seen from the above, the operation 120 for separating the deterministic part uses the temporal vibratory signal x[n] and the position signal θ[n] as measured in step 110, to generate a random residual signal r[n]. It also uses parameters such as the delay Δ in number of samples and the filter length N_{f} in number of samples. These parameters can be set by the operator or defined by default with

$$Δ = \frac{{F}_{s}}{{B}_{w}} * {N}_{rev}$$

(where Nᵣₑᵥ is the number of angular samples per cycle of the reference tree) and

$${N}_{f} = \frac{1}{{FTF}^{the}} .$$

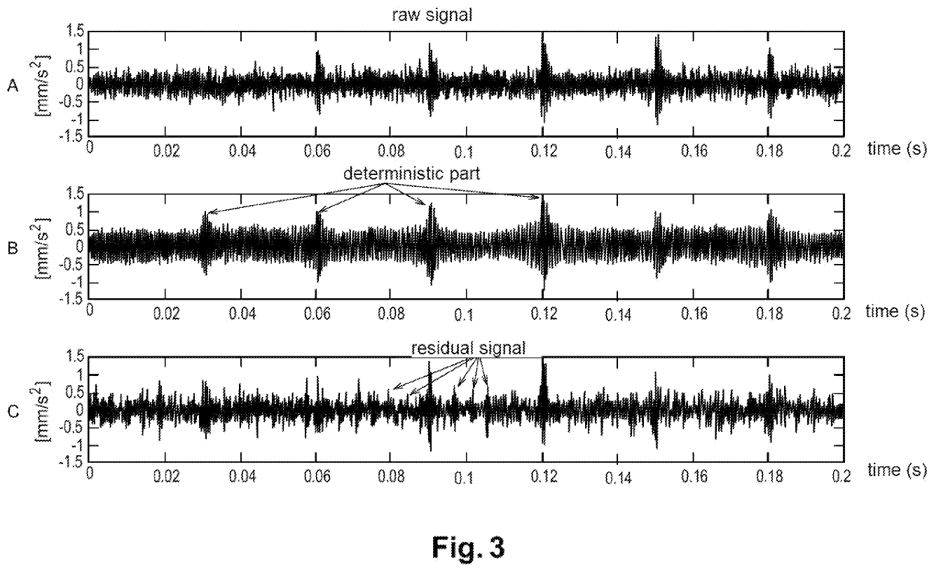

Examples of the raw vibratory signal, as acquired in step 110, of the deterministic part of the vibratory signal and of the random residual signal, obtained by applying operation 120 for separating the deterministic part, are represented, respectively, in parts A, B and C of FIG. 3. The raw vibratory signal shows, in part A, a few pulses related to a defect in an element of the rotating system other than the bearing, for example a gear defect. The deterministic signal, i.e. the deterministic part of the vibratory signal, clearly shows these pulses on part B of FIG. 3, thus indicating the meshing period. The random residual signal, obtained at the end of operation 120, clearly shows, on part C of FIG. 3, the pulses generated by an outer race defect. By comparing part A and part C, it can be seen that the outer race defect was completely masked by the deterministic signal in the raw vibratory signal. Operation 120 has therefore made it possible to highlight the vibratory signal specific to the bearing defect.

Step 130: The method 100 then includes an operation 130 for calculating defect frequency bounds. It is generally accepted that bearing defect frequencies are subject to a deviation generated by the change in contact angle during movement. Actual defect frequencies are therefore significantly different from those calculated theoretically. It is therefore useful to estimate intervals of uncertainty in the bearing defect frequencies, the estimation of these intervals corresponding to the calculation, for each defect frequency, of a lower bound and an upper bound of the defect frequencies. To do this, we designate ε the uncertainty of the cage defect frequency and we estimate the uncertainty intervals (u the lower and upper bounds) for the four bearing defect frequencies (outer race defect, inner race defect, cage defect and ball defect), as a function of the uncertainty ε of the cage defect frequency, based on the linear relationship between the defect frequencies of the other bearing elements and that of the cage. More precisely, the characteristic frequencies of the bearing elements, as a function of the cage defect frequency (FTF), are expressed as follows:
Outer race defect frequency (BPFO):

BPFO=N_{b}FTF
Inner race defect frequency (BPFI):

$$BPFI = {N}_{b} ( 1 - FTF )$$

Ball or other rolling element defect frequency (BSF):

$$BSF = {N}_{b} ( 1 - \frac{PD}{BD} ) FTF$$

Based on the above formulae, the uncertainty intervals for bearing defect frequencies are calculated as follows:
BPFO frequency uncertainty interval:

$${I}_{BPFO} = [ {BPFO}^{Low} ; {BPFO}^{Hi} ] = [ {BPFO}^{the} ( 1 - ϵ ) ; {BPFO}^{the} ( 1 + ϵ ) ]$$

BPFI frequency uncertainty interval:

$${I}_{BPFI} = [ {BPFI}^{Low} ; {BPFI}^{Hi} ] = [ {BPFI}^{the} - ϵ \cdot {BPFO}^{the} ; {BPFI}^{the} + ϵ \cdot {BPFO}^{the} ]$$

BSF frequency uncertainty interval:

$${I}_{BSF} = [ {BSF}^{Low} ; {BSF}^{Hi} ] = [ {BSF}^{the} ( 1 - ϵ ) ; {BSF}^{the} ( 1 + ϵ ) ]$$

Frequency uncertainty interval FTF:

$${I}_{FTF} = [ {FTF}^{Low} ; {FTF}^{Hi} ] = [ {FTF}^{the} ( 1 - ϵ ) ; {FTF}^{the} ( 1 + ϵ ) ]$$

This operation 130 for calculating frequency bounds requires the theoretical characteristic vector of the bearing as input data V^{the}=[BPFO^{the}, BPFI^{the}, BSF^{the}, FTF^{the}, SRF] as input data, and generates a lower bound V^{Low}=[BPFO^{Low}, BPFI^{Low}, BSF^{Low}, FTF^{Low}, SRF] and an upper bound V^{Hi}=[BPFO^{Hi}, BPFI^{Hi}, BSF^{Hi}, FTF^{Hi}, SRF] for each of the four defect frequencies. This operation 130 uses, as a parameter, the uncertainty ε on the frequency of the cage defect and the length of the filter N_{f} in numbers of samples. The uncertainty parameter ε parameter can be predefined by the operator or set to 0.03 by default.

It should be noted that the bearing characteristic vector is a user-configured input comprising the characteristic frequencies of the bearing being monitored. Each bearing is defined by four characteristic frequencies, thus by its rotation frequency. These frequencies for outer race failure, inner race failure, ball failure and cage failure are calculated using formulas known to the skilled person and referred to previously.

The operations 120 and 130 just described can be carried out one after the other, in any order, or simultaneously if the data processing device allows.

Step 140: The method 100 then includes an operation 140 for calculating the spectral coherence, carried out following the operation 120 for separating the deterministic part of the vibratory signal. The spectral coherence is a complex quantity defined on the basis of the residual signal, as described below. Operation 140 uses, as input data, the resampled (in angle) vibratory signal determined during operation 110. It also uses, as parameters, the angular offset R, the window size Nw, the uncertainty e on the frequency of the cage defect and the length of the filter N_{f} in numbers of samples. The angular offset R and the window size Nw can be set by the operator or defined by default. When set as default:

$${N}_{w} = nextpow 2 ( 25 * {N}_{rev} ) \\ R = floor ( \frac{{N}_{rev}}{2 ( {H}_{d} \cdot {BPFI}^{Hi} + ( 1 + {H}_{M} ) \cdot SRF )} )$$

where Hd and Hm, which designate the number of defect harmonics and the number of pairs of side lines in the signature under consideration, have values of 6 and 3 respectively.

It is widely accepted in the scientific community that the nature of the bearing defect signal is cyclostationary (of order 2). Cyclostationary methods have been shown to be effective in the detection and identification of bearing defects. A number of studies have focused on different second-order statistical tools, such as the envelope squared spectrum, spectral correlation, spectral coherence and integrated spectral coherence. These different tools are described especially in: (1) Jérôme Antoni, Cyclic spectral analysis in practice, Mechanical Systems and Signal Processing, Volume 21, Issue 2, 2007, Pages 597-630, ISSN 0888-3270; (2) J. Antoni, Cyclic spectral analysis of rolling-element bearing signals: Facts and fictions, Journal of Sound and Vibration 304 (2007) 497-529; (3) Antoni J., Cyclostationarity by examples. Mech. Syst. and Sign. Proc. 23 (2009) 987-1036.

For these reasons, the amplitude of spectral coherence is an important tool for revealing the symptoms of a bearing defect and helps to pinpoint these frequencies precisely. Spectral coherence is the normalised version of spectral correlation, defined as the double Fourier transform of the autocorrelation function. Spectral correlation is defined by:

$${S}_{2 r} ( α , f ) = {ℱ}_{{t \to α}_{τ \to f}} \{ E \{ r ( t ) r ( t - τ ) \} \}$$

Spectral coherence has a bounded amplitude between 0 and 1 and indicates the intensity of cyclostationarity in terms of the signal-to-noise ratio. It is defined as follows:

$${γ}_{2 r} ( α , f ) = \frac{{S}_{2 r} ( α , f )}{{[ {S}_{2 r} ( f ) {S}_{2 r} ( f + α ) ]}^{1 / 2}}$$

where S₂ₓ(f)=S₂ₓ(0, f) is the power spectrum. In method 100, fast spectral correlation is applied to the residual signal r[nₐ] where nₐ denotes the index related to the angular variable r(θ)=r(nₐΔθ)=r[nₐ].

The fast spectral correlation estimator is based on the short-term Fourier transform of the signal, as described in Jérôme Antoni, Ge Xin, Nacer Hamzaoui, Fast computation of the spectral correlation, Mechanical Systems and Signal Processing, Volume 92, 2017, Pages 248-277, ISSN 0888-3270.

The estimator of the fast spectral correlation is based on the short-term Fourier transform of the signal, as described in Jérôme Antoni, Ge Xin, Nacer Hamzaoui, Fast computation of the spectral correlation, Mechanical Systems and Signal Processing, Volume 92, 2017, Pages 248-277, ISSN 0888-3270. This estimator is then written:

$${R}_{STFT} ( i , {a}_{k} ) = {\sum }_{m = 0}^{{N}_{w} - 1} r [ i R + m ] w ( m ) {e}^{- j 2 π m {a}_{k} / M}$$

where aₖ=kΔa, k=0, . . . N_{w}−1 is the spectral frequency in [evts/rev], M is the number of samples per revolution, Δa is the spectral resolution equal to

$$Δ a = \frac{M}{{N}_{w}} w$$

is a symmetrical window of size Nw with a central index N₀ such that w[N₀+n]=w[N₀−n] (with

$${N}_{0} = \frac{{N}_{w}}{2}$$

if N_{w} is even and

$${N}_{0} = \frac{{N}_{w} + 1}{2}$$

otherwise), R is the offset between two consecutive windows.

Expressing the spectral frequency in Hz gives: R_{STFT}(i, fₖ)=R_{STFT}(i, aₖ=fₖ/f̅_{ref}) where fₖ=kΔf=kΔaf̅_{ref} and where Δf is the spectral resolution in Hz.

Before defining the fast spectral correlation, it is important to define the scanning spectral correlation, which is as follows:

$${S}_{2 r} ( α , {f}_{k} ; p ) = \frac{1}{K {‖ w ‖}^{2} M} D F T \{ {R}_{STFT} ( i , {f}_{k} ) {{R}_{STFT} ( i , {f}_{k - p} )}^{*} \} {e}^{- j 2 π {N}_{0} ( \frac{α}{M} - \frac{p}{{N}_{w}} )} .$$

The fast spectral correlation is then expressed as follows:

$${S}_{2 r}^{( fast )} ( α , {f}_{k} ) = \frac{{\sum }_{p = 0}^{P} {s}_{2 r} ( α , {f}_{k} ; p )}{{\sum }_{D = 0}^{P} {R}_{w} ( α - p Δ f )} {R}_{w} ( 0 )$$

with P=floor(N_{w}/2R) where the floor(*) function rounds the real input to the smallest integer) and where R_{w}(α) is the window autocorrelation function. Fast spectral coherence can be written as:

$${γ}_{2 r}^{( fast )} ( α , {f}_{k} ) = \frac{{S}_{2 r}^{( fast )} ( α , {f}_{k} )}{{[ {S}_{2 r}^{( fast )} ( 0 , {f}_{k} ) {S}_{2 r}^{( fast )} ( 0 , {f}_{k} + α {\overline{f}}_{ref} ) ]}^{1 / 2}}$$

Spectral coherence is a complex quantity. Analysis of the square of its amplitude reveals the presence of a bearing defect. The square of the amplitude of spectral coherence is defined as follows:

$${Γ}_{2 r}^{( fast )} ( α , {f}_{k} ) = {γ}_{2 r}^{( fast )} ( α , {f}_{k} ) {{γ}_{2 r}^{( fast )} ( α , {f}_{k} )}^{*} = {\vert {γ}_{2 r}^{( fast )} ( α , {f}_{k} ) \vert}^{2}$$

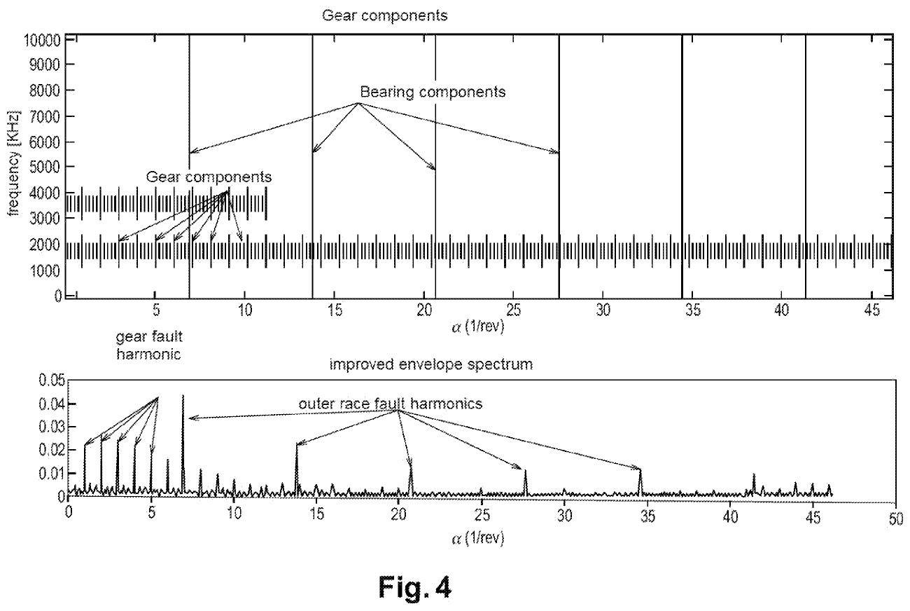

FIG. 4 represents an example of the application of spectral coherence to the residual part of the vibratory signal. FIG. 4 shows spectral lines parallel to the frequency axis and located on the outer race defect frequency and its harmonics. This indicates the presence of second-order cyclostationarity, which is symptomatic of a bearing defect. The intensity of the spectral lines intensifies over a wide band, between 4 and 8 kHz, indicating the presence of resonance in this zone. The integrated spectral coherence is also calculated by averaging the spectral coherence with respect to the spectral frequency variable. The resulting spectrum, also known as the “enhanced envelope spectrum”, is a good indicator for bearing defect detection. The bearing defect signature is clearly visible in this spectrum. It should be noted that a gear-related component still exists and can be seen in the spectral coherence thus in the improved envelope spectrum.

Step 150: The method 100 then includes an operation 150 for calculating the actual characteristic vector of the bearing, also called the current characteristic vector. This operation 150, which enables the true defect frequencies (“true” as opposed to theoretical frequencies) to be identified, uses as input data the diagnostic indicator obtained at the end of operation 140, i.e. the square of the amplitude of the spectral coherence. It also uses, as input data, the lower and upper frequency bounds determined during operation 130.

Because of the deviation from the characteristic frequency, the method provides an estimate of the most likely defect frequency, assuming that it lies within the frequency bounds calculated in operation 130. It is expected that, at the most likely frequency, cyclostationarity will be strongest with the presence of multiple harmonics. The criterion used to identify the most likely defect frequency consists of locating the peaks in the square of the amplitude of the integrated spectral coherence. The square of the amplitude of the integrated cyclic coherence is expressed as follows:

$${ICC}_{r}^{( fast )} ( α ) = {\sum }_{k} {Γ}_{2 r}^{( fast )} ( α , {f}_{k} )$$

A peak is defined by the presence of a value greater than two neighbouring samples (two samples to the right and two to the left). Peaks relating to multiples of the bearing shaft rotation frequency are considered to be unwanted interference and are not taken into account. The peaks around the two harmonics are compared to find potential harmonics. The actual defect frequency is the one with the highest energy and multiple harmonic. If the second harmonic is not present, the frequency associated with the maximum amplitude of ICCᵣ^{(fast)}(α) around the first harmonic is used. Note that modulations are not taken into account in this step.

Operation 150 calculates the current defect frequency for each of the four characteristic bearing defect frequencies by virtue of the square of the amplitude of the integrated spectral coherence. For example, for the outer race defect frequency BPFO^{Low} and BPFO^{Hi} are used to delimit the uncertainty interval of the defect frequency. The method is then applied to the fast spectral coherence Γ₂ᵣ^{(fast)}(α, fₖ) to obtain the most likely current frequency of the outer race defect. The same methodology is applied for each of the four defect frequencies (outer race, inner race, cage and ball). The output of operation 150 is the current characteristic vector of the bearing: V^{act}=[BPFO^{act}, BPFI^{act}, BSF^{act}, FTF^{act}, SRF].

Step 160: The method 100 includes, following operation 150, an operation 160 for estimating the frequency support of the signatures of the bearing defects using, as input data, the square of the amplitude of the fast spectral coherence Γ₂ᵣ^{(fast)}(α, fₖ) the lower bound of the characteristic frequencies V^{Low}=[BPFO^{Low}, BPFI^{Low}, BSF^{Low}, FTF^{Low}, SRF], the upper bound of the characteristic frequencies V^{Hi}=[BPFO^{Hi}, BPFI^{Hi}, BSF^{Hi}, FTF^{Hi}, SRF] and the current characteristic vector of the bearing. V^{act}=[BPFO^{act}, BPFI^{act}, BSF^{act}, FTF^{act}, SRF]. This step 160 also uses parameters such as H_{d} the number of harmonics considered for the defect signature and Hₘ the number of pairs of sidebands considered for the defect signature. These parameters can be defined by the operator; they can also be defined by default with, for example, H_{d}=6 and Hₘ=3.

Operation 160 provides a means of calculating the spectral cyclic contrasts of bearing defects. A cyclic contrast is calculated for each of the potential defects using the associated characteristic defect frequency. The cyclic contrast can be calculated, as described below, using the variable α_{d}, which is the frequency of the suspected defect, and the variable αₘ, which is its potential modulation. Indeed, the detection and identification of a defect are based on the presence of cyclosationnarity in the signal associated with the different signatures of the defect (according to the type of defect). With this in mind, method 100 uses the envelope spectrum or the square of the amplitude of the integrated cyclic coherence, ICCᵣ^{(fast)}(α) in relation to the spectral frequency. Such an indicator is relevant for early defect detection, and provides superior results compared to sophisticated state-of-the-art methods such as that described in Abboud, M. Elbadaoui, W. A. Smith, R. B. Randall, “Advanced bearing diagnostics: A comparative study of two powerful approaches”, Mechanical Systems and Signal Processing, Volume 114, 2019, Pages 604-627.

Despite the effectiveness of this approach, it is also possible to improve defect detection by using a priori knowledge of kinematics and thus identifying the most likely current defect frequencies. This improvement in defect detection is based on the contrast of a signature in the square of the amplitude of the spectral coherence.

The contrast of a signature, in the general case of a bearing defect signature comprising the defect frequency f_{d} and its multiple harmonics modulated by a frequency fₘ, is explained below. For example, in the case of an inner race defect signature, the frequency f_{d} is the inner race defect frequency (BPFI) and fₘ is the bearing shaft rotation frequency (SRF). If [symbol] (α_{d}, αₘ)={h_{d}α_{d}+hₘαₘ/h_{d}=1 . . . H_{d}, hₘ=±1, ±2 . . . +Hₘ} is used, the signature of a defect at frequency (or order) α_{d} having a modulation at frequency (or order) αₘ, the contrast of the signature S in any function Z(α) (where α denotes the frequency or order variable in [evt/rev]) is defined as the amplitude of the harmonics associated with this signature divided by the average of the background noise around its peaks. The contrast of the S signature is then determined by calculating the sum of the amplitudes of the same signature calculated at frequencies close to that of the defect. The contrast of the signature [symbol] (α_{d}, αₘ) in Z(α) is defined as follows:

$$\tilde{E} ( Z ( α ) , 𝒮 ( {α}_{d} , {α}_{m} ) ) = \frac{{\sum }_{{α}_{i} ∈ 𝒮 ( {α}_{d} , {α}_{m} )} Z ( {α}_{i} )}{median ( {\sum }_{{α}_{i} ∈ 𝒮 ( {α}_{d} + {δ}_{1} , {α}_{m} )} Z ( {α}_{i} ) , … , {\sum }_{{α}_{i} ∈ 𝒮 ( {α}_{d} + {δ}_{J} , {α}_{m} )} Z ( {α}_{i} ) )}$$

where δⱼ is a uniform random variable over a window of size σ_{δ} centered at α_{d} and defined on [α_{d}−σ_{δ}/2; α_{d}+σ_{δ}/2]. The median is equivalent to the amplitude of the background noise and is immune to large peak values. If there is no peak, the sum of the peaks is very close to the mean of the background noise and the contrast tends towards 1. If one or more peaks are present, the contrast increases with the amplitude and the number of harmonics. In order to centre the contrast at zero, it is convenient to define the centred emergence by subtracting the value 1 from the contrast. The signature contrast is then:

$$E ( x ( α ) ; 𝒮 ( {α}_{d} , {α}_{m} ) ) = \tilde{E} ( x ( α ) , 𝒮 ( {α}_{d} , {α}_{m} ) ) - 1$$

In the absence of a signature, the contrast remains close to zero. In the presence of a signature, the contrast increases.

The spectral cyclic contrast of a signature for a signal z[n] is simply the contrast, centred, applied to the square of the amplitude of the spectral coherence Γ_{2z}(α, f):

$$Ξ ( {f}_{k} ; z , 𝒮 ( {α}_{d} , {α}_{m} ) ) = E ( {Γ}_{2 z} ( α , {f}_{k} ) ; 𝒮 ( {α}_{d} , {α}_{m} ) ) ∀ k$$

Spectral cyclic contrast is a function of spectral frequency. It identifies the spectral frequencies that exhibit cyclostationarity to this signature (the contrast for these frequencies is greater than zero). The aim of this function is to calculate the signatures associated with the four types of defect (outer race, inner race, cage and ball) and determine the spectral cyclic contrast for each of the defect frequencies.

As a reminder, the number of defect harmonics and side lines are noted by H_{d} and Hₘ respectively. We therefore consider Ha defect harmonics with 2Hₘ modulations. Using the current characteristic vectors of the bearing including the most probable defect frequencies, the different defect signatures are: .
a1) Signature of the outer race defect:

$${𝒮}_{BPFO} = 𝒮 ( {BPFO}^{act} , ∼ ) = \{ {h}_{d} {BPFO}^{act} / {h}_{d} = 1 … {H}_{d} \}$$

a2) Signature of the inner race defect:

$${𝒮}_{BPFI} = 𝒮 ( {BPFI}^{act} , SRF ) = \{ {h}_{d} {BPFI}^{act} + {h}_{m} SRF / {h}_{d} = 1 … {H}_{d} , {h}_{m} = \pm 1 , \pm 2 … \pm {H}_{m} \}$$

a3) Signature of the ball (or other rolling element) defect:

$${𝒮}_{BSF} = 𝒮 ( {BSF}^{act} , {FTF}^{act} ) = \{ {h}_{d} {BSF}^{act} + {h}_{m} {FTF}^{act} / {h}_{d} = 1 … {H}_{d} , {h}_{m} = \pm 1 , \pm 2 … \pm {H}_{m} \}$$

a4) Signature of the cage defect:

$${𝒮}_{FTF} = 𝒮 ( {FTF}^{act} , ∼ ) = \{ {h}_{d} {FTF}^{act} / {h}_{d} = 1 … {H}_{d} \}$$

The spectral cyclic contrasts can then be calculated. The spectral cyclic contrasts associated with each of the defects are:
b1) Signature of the outer race defect:

$${E}_{BPFO} ( {f}_{k} ) = Ξ ( {f}_{k} ; r , 𝒮 ( {BPFO}^{act} , ∼ ) ) ∀ k$$

b2) Signature of the inner race defect:

$${E}_{BPFI} ( {f}_{k} ) = Ξ ( {f}_{k} ; r , 𝒮 ( {BPFI}^{act} , SRF ) ) ∀ k$$

b3) Signature of the ball (or other rolling element) defect:

$${E}_{BSF} ( {f}_{k} ) = Ξ ( {f}_{k} ; r , 𝒮 ( {BSF}^{act} , {FTF}^{act} ) ) ∀ k$$

b4) Signature of the cage defect:

$${E}_{FTF} ( {f}_{k} ) = Ξ ( {f}_{k} ; r , 𝒮 ( {FTF}^{act} , ∼ ) ) ∀ k$$

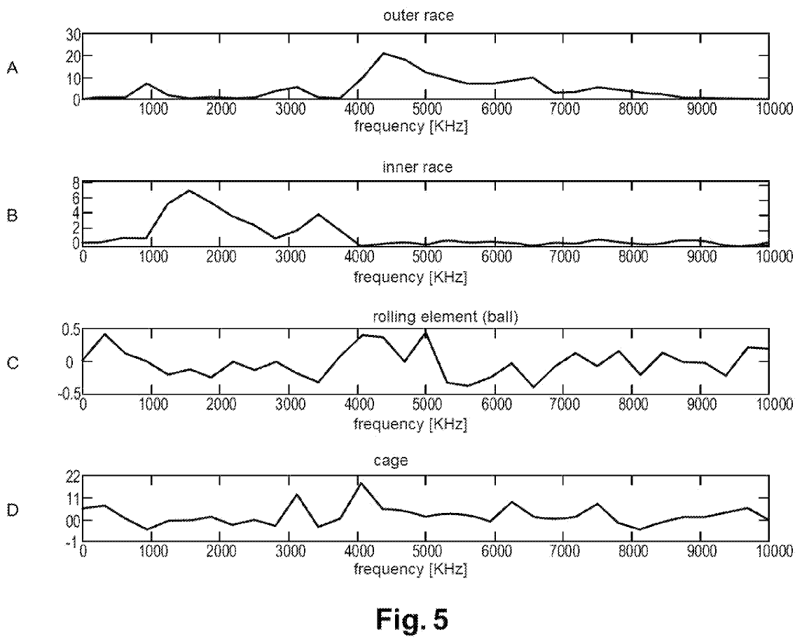

Examples of spectral cyclic contrasts for the four types of defect are represented in FIG. 5, with the frequency on the x-axis and the percentage contrast on the y-axis. In FIG. 5, part A shows an example of spectral cyclic contrast for an outer race defect; part B shows an example of spectral cyclic contrast for an inner race defect; part C shows an example of spectral cyclic contrast for a ball defect; part D shows an example of spectral cyclic contrast for a cage defect. The example in FIG. 5 shows that the distribution associated with the outer race has high contrast values ranging from 2 to 4.5 kHz and that the band undergoing an increase in spectral cyclic contrast is relative to the spectral band of the bearing resonance (compare with the spectral coherence in FIG. 4). This corresponds well to what is sought within the scope of the invention: to find an image of the dynamic characteristics of the bearing in order to use these to improve the defect signature. This resonance zone extends between 4 kHz and 5 kHz. With regard to the spectral cyclic contrast associated with the inner race, there is an increase (less significant than that of the outer race) between 1 kHz and 4 kHz, but this spectral zone is related to the dynamics of the gear, which means that the system must have considered a harmonic related to the gear residue to be an inner race harmonic. However, as the calculation of the spectral cyclic contrast is based on several harmonics and modulations (as defined in the signature), the effect of this error remains small and does not affect the implementation of the process. In fact, considering a signature instead of a harmonic makes the identification of the system's dynamic properties more robust. Furthermore, FIG. 5 shows that the spectral cyclic contrasts relating to the ball and cage defects are not informative and show no increase over a particular frequency band.

Step 170: The method 100 includes, following step 160, an operation 170 of fine identification of signatures of interest. The fine identification of a signature of interest is the exact identification of the frequency of the defect through the vector V^{act}=[BPFO^{act}, BPFI^{act}, BSF^{act}, FTF^{act}, SRF]. The defect frequencies of a bearing deviate from their theoretical frequencies, which makes detection more complicated. Operation 170 makes it possible to identify these frequencies, and therefore the signatures, in a precise manner. This operation 170 consists of using, for each of the four types of defect (outer race, inner race, ball and cage), the spectral cyclic contrast calculated in the previous step to weight the spectral coherence and then integrate it in relation to a spectral frequency variable. fk. This operation 170 highlights weak signatures that may be found in narrow frequency bands. The weighting is calculated for each of the four spectral cyclic contrasts, determined in step 160, associated with the four types of defect. Step 170 first provides a means of limiting and normalising the spectral cyclic contrast so that the overall cyclostationarity content is not modified in the spectral coherence. To achieve this, the following non-normalised signature filter is used:

$$\tilde{W} ( {f}_{k} ) = \tilde{W} ( {f}_{k} ; z , 𝒮 ( {α}_{d} , {α}_{m} ) ) = \frac{Ξ ( {f}_{k} ; z , 𝒮 ( {α}_{d} , {α}_{m} ) ) - {min ( Ξ ( {f}_{k} ; z , 𝒮 ( {α}_{d} , {α}_{m} ) ) )}_{{f}_{k}}}{{max ( Ξ ( {f}_{k} ; z , 𝒮 ( {α}_{d} , {α}_{m} ) ) )}_{{f}_{k}} - {min ( Ξ ( {f}_{k} ; z , 𝒮 ( {α}_{d} , {α}_{m} ) ) )}_{{f}_{k}}}$$

where

$${min ( Ξ ( {f}_{k} ; z , 𝒮 ( {α}_{d} , {α}_{m} ) ) )}_{{f}_{k}} and {max ( Ξ ( {f}_{k} ; z , 𝒮 ( {α}_{d} , {α}_{m} ) ) )}_{{f}_{k}}$$

are, respectively, the minimum and maximum with respect to the variable fₖ. The normalised weight is:

$$W ( {f}_{k} ; z , 𝒮 ( {α}_{d} , {α}_{m} ) ) = \frac{\tilde{W} ( {f}_{k} )}{{σ}_{\tilde{W}}}$$

where σ_{\tilde{W}} is the standard deviation d\tilde{W}(fₖ).

In order to highlight the signature of interest, or suspicious signature, i.e. the signature of a defect corresponding to a bearing defect (and not to a defect in an environmental device, such as a gear defect), the method 100 provides for the integration of a weighted average of the square of the amplitude of the cyclic coherence with respect to the spectral frequency variable fₖ. The integrated weighted cyclic coherence associated with the signature [symbol] (α_{d}, αₘ) is then:

[symbol]

(α)= [symbol] Γ_{2z}(α, fₖ)W(fₖ;z, [symbol] (α_{d}, αₘ)) [symbol] _{f}_{ₖ}

Firstly, the weight associated with each of the four types of defect is calculated as shown above, using the non-normalised filter. \tilde{W}(fₖ). The weight for each of the four defects is as follows:
Outer race defect:

$${W}_{BPFO} ( {f}_{k} ; z , 𝒮 ( {α}_{d} , {α}_{m} ) ) = \frac{{\tilde{W}}_{BPFO} ( {f}_{k} )}{{σ}_{{\tilde{W}}_{BPFO}}}$$

where

$${\tilde{W}}_{BPFO} ( {f}_{k} ) = \frac{{E}_{BPFO} ( {f}_{k} ) - {min ( {E}_{BPFO} ( {f}_{k} ) )}_{{f}_{k}}}{{max ( {E}_{BPFO} ( {f}_{k} ) )}_{{f}_{k}} - {min ( {E}_{BPFO} ( {f}_{k} ) )}_{{f}_{k}}}$$

is the non-normalised weight associated with the outer race signature.
Inner race defect:

$${W}_{BPFI} ( {f}_{k} ; z , 𝒮 ( {α}_{d} , {α}_{m} ) ) = \frac{{\tilde{W}}_{BPFI} ( {f}_{k} )}{{σ}_{{\tilde{W}}_{BPFI}}}$$

$$where$$

$${\tilde{W}}_{BPFI} ( {f}_{k} ) = \frac{{E}_{BPFI} ( {f}_{k} ) - {min ( {E}_{BPFI} ( {f}_{k} ) )}_{{f}_{k}}}{{max ( {E}_{BPFI} ( {f}_{k} ) )}_{{f}_{k}} - {min ( {E}_{BPFI} ( {f}_{k} ) )}_{{f}_{k}}}$$

is the non-normalised weight associated with the inner race signature.
Ball (or other rolling element) defect:

$${W}_{BPFI} ( {f}_{k} ; z , 𝒮 ( {α}_{d} , {α}_{m} ) ) = \frac{{\tilde{W}}_{BSF} ( {f}_{k} )}{{σ}_{{\tilde{W}}_{BSF}}}$$

$$where$$

$${\tilde{W}}_{BSF} ( {f}_{k} ) = \frac{{E}_{BSF} ( {f}_{k} ) - {min ( {E}_{BSF} ( {f}_{k} ) )}_{{f}_{k}}}{{max ( {E}_{BSF} ( {f}_{k} ) )}_{{f}_{k}} - {min ( {E}_{BSF} ( {f}_{k} ) )}_{{f}_{k}}}$$

is the non-normalised weight associated with the ball signature.
Cage defect:

$${W}_{FTF} ( {f}_{k} ; z , 𝒮 ( {α}_{d} , {α}_{m} ) ) = \frac{{\tilde{W}}_{FTF} ( {f}_{k} )}{{σ}_{FTF}}$$

$$where$$

$${\tilde{W}}_{FTF} ( {f}_{k} ) = \frac{{E}_{FTF} ( {f}_{k} ) - {min ( {E}_{FTF} ( {f}_{k} ) )}_{{f}_{k}}}{{max ( {E}_{FTF} ( {f}_{k} ) )}_{{f}_{k}} - {min ( {E}_{FTF} ( {f}_{k} ) )}_{{f}_{k}}}$$

is the non-normalised weight associated with the cage signature.

Secondly, the non-normalised weight associated with each of the four types of defect is integrated, as indicated above, with respect to the variable fₖ. The weighted integrated cyclic coherences obtained for the defect signatures are then:
Outer race defect: [symbol] _{BPFO}(α)= [symbol] Γ₂ᵣ^{(fast)}(α, fₖ)W_{BPFO}(fₖ) [symbol] fₖ
Inner race defect: [symbol] _{BPFI}(α)= [symbol] Γ₂ᵣ^{(fast)}(α, fₖ)W_{BPFI}(fₖ) [symbol] fₖ
Ball defect: [symbol] _{BSF}(α)= [symbol] Γ₂ᵣ^{(fast)}(α, fₖ)W_{BSF}(fₖ) [symbol] fₖ
Cage defect: [symbol] _{FTF}(α)= [symbol] Γ₂ᵣ^{(fast)}(α, fₖ)W_{FTF}(fₖ) [symbol] fₖ

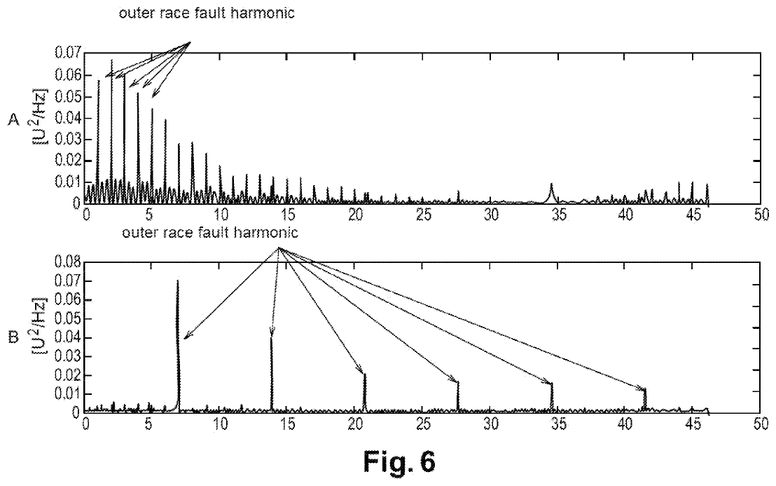

FIG. 6 represents, in part A, an example of integrated spectral coherence and, in part B, an example of weighted integrated spectral coherence for an outer race defect. The integrated spectral coherence and the integrated and weighted spectral coherence are calculated to assess the latter's ability to extract a weak signature. The example in FIG. 6 shows that the signature of the outer race defect emerges in the integrated and weighted coherence, with weighting having the effect of bringing out a weak signature, even a very weak one.

Step 180: The method 100 then includes an operation 180 for determining diagnostic indicators, quantifying the presence of a given signature. This operation 180 uses, as input data, the weighted integrated cyclic coherence associated with the outer race defect, the weighted integrated cyclic coherence associated with the inner race defect and the weighted integrated cyclic coherence associated with the outer race defect. [symbol] _{BPFO}(α) the weighted integrated cyclic coherence associated with the inner race defect [symbol] _{BPFI} the weighted integrated cyclic coherence associated with the ball (or other rolling element) defect [symbol] _{BSF}(α) the weighted integrated cyclic coherence associated with the cage defect [symbol] _{BSF}(α) and the residual signal r[n] to obtain four spectra highlighting potential defect signatures. These spectra enhance weak signatures and make them stand out in the distribution. For each signature, three diagnostic indicators are provided:
The contrast of the signature in the weighted integrated cyclic coherence, described above;
The contrast of the signature in the envelope spectrum of the residual signal, described later; and
The signature relevance indicator, defined below.

The relevance indicator of a signature [symbol] (α_{d}, αₘ) in a given spectrum x(α) is a score between 0 and 1 describing the presence of peaks in the spectrum according to the ratio between the number of harmonics present and the number of harmonics expected. A harmonic in the spectrum is considered present if its emergence exceeds a given threshold. This threshold can be set, for example, at 2. Signature relevance is defined as follows:

$$𝒫 ( x ( α ) ; 𝒮 ( {α}_{d} , {α}_{m} ) ) = \frac{{\sum }_{{α}_{i} ∈ 𝒮 ( {α}_{d} , {α}_{m} )} {1}_{E ( x ( α ) ; \{ {α}_{i} \} ) \geq 2}}{card \{ 𝒮 ( {α}_{d} , {α}_{m} ) \}}$$

where card{*} defines the cardinal of a variable (the number of elements) and 1condition is the function of the indicator. This function is equal to 1 when the condition is true (i.e. when the peak contrast exceeds the value 2) and equal to 0 in other cases.

The contrast of the signature in the envelope spectrum of the residual signal consists of applying the contrast of each defect signature to the square of the signal envelope, the signal envelope being the absolute value of the analytical signal obtained through the Hilbert transform H{[n]}: SESᵣ(α)=DTFT{|H{r[n]}|²}.

In this operation 180, the spectrum of the square of the signal envelope is calculated thus three scalar indicators for each type of defect, each indicator being calculated in a sub-function. The first sub-function, used to calculate a first indicator for each of the four types of defect, includes the calculation of the contrast of the signature in the weighted integrated cyclic coherence for each type of defect (outer race, inner race, ball and cage):
Outer race defect: [symbol] _{BPFO}^{Coh}=E( [symbol] _{BPFO}(α), [symbol] _{BPFO})
Inner race defect: [symbol] _{BPFI}^{coh}=E( [symbol] _{BPFI}(α), [symbol] _{BPFI})−1
Ball or other rolling element defect: [symbol] _{BSF}^{coh}=E( [symbol] _{BSF}(α), [symbol] _{BSF})
Cage defect: [symbol] _{FTF}^{coh}=E( [symbol] _{FTF}(α), [symbol] _{FTF})

A second sub-function then calculates a second indicator for each of the four types of defect. This second sub-function consists of calculating the contrast of the signature in the spectrum of the square of the envelope. To do this, the spectrum of the square of the envelope of the residual signal is first calculated and then the four contrast indicators for the four types of defect are calculated:
Outer race defect: [symbol] _{BPFO}^{env}=E(SESᵣ(α), [symbol] _{BPFO})
Inner race defect: [symbol] _{BPFI}^{env}=E(SESᵣ(α), [symbol] _{BPFI})
Ball or rolling element defect: [symbol] _{BSF}^{env}=E(SESᵣ(α), [symbol] _{BSF})
Cage defect: [symbol] _{FTF}^{env}=E(SESᵣ(α), [symbol] _{FTF})

A third sub-function is then applied to calculate a third indicator for each of

the four types of defect. This third sub-function consists of a calculation of the relevance of the signature in the weighted integrated cyclic coherence, for each of the four types of defect:
Outer race defect: [symbol] _{BPFO}= [symbol] ( [symbol] _{BPFO}(α), [symbol] _{BPFO})
Inner race defect: [symbol] _{BPFI}= [symbol] ( [symbol] _{BPFI}(α), [symbol] _{BPFI})
Ball or other rolling element defect: [symbol] _{BSF}= [symbol] ( [symbol] _{BSF}(α), [symbol] _{BSF})
Cage defect: [symbol] _{FTF}= [symbol] ( [symbol] _{FTF}(α), [symbol] _{FTF})

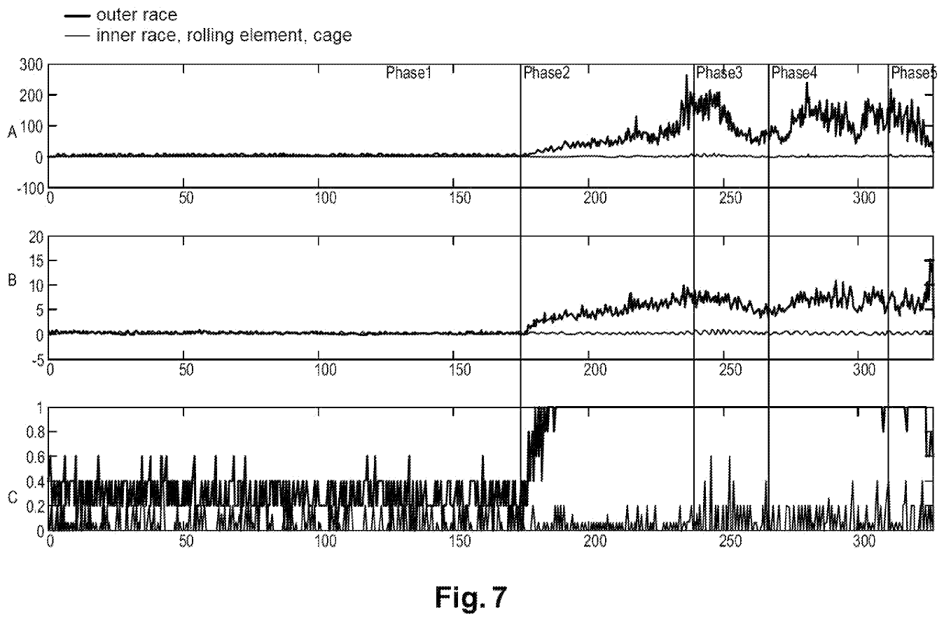

These three types of indicators can, for example, be applied to the data acquired by the accelerometer and saved in the database. An example of the evolution of these three indicators, calculated for each of the four types of defect, is represented in FIG. 7. Part A of FIG. 7 represents changes in coherence contrast; part B of FIG. 7 represents changes in envelope contrast; part C of FIG. 7 represents changes in signature relevance. Each of these parts A, B and C comprises four curves, each associated with one of the four possible types of defect (outer race defect, inner race defect, ball defect and cage defect). The advantage of these indicators is their ability to accurately identify the different phases in the evolution of the curves and to provide the operator with a large amount of information about the defect signature. These diagnostic indicators can be interpreted as follows:
Phase 1: During this phase, all three indicators are constant. The contrast in coherence (part A) has an average value of approximately 5, indicating that a very small outer race signature already exists in the signal. The envelope contrast (part B) is close to zero, indicating that this signature is energetically very small and does not yet emerge in the envelope spectrum of the signal. The outer race signature relevance indicator (part C) shows a value fluctuating between 0.2 and 0.4, indicating the presence of one or two outer race harmonics in the weighted integrated coherence. Upon reading these indicators, we can see that the outer race signature is very weak and that there is no defect. These indicators probably explain a susceptibility or fragility in the outer race.
Phase 2: During this phase, all three indicators increase significantly. The signature emerges in the coherence and envelope (parts A and B) and the number of harmonics increases and exceeds 5 (these indicators are calculated for M=5 harmonics). This change clearly shows the emergence of an outer race defect. This phase is clearly defined by the indicators and relatively easy to interpret.
Phase 3: In this phase, a decrease in the contrast indicators in the coherence and envelope (parts A and B) is observed, while the number of harmonics remains above 5 harmonics (the relevance indicator is equal to 1). This implies that the energy of the signature is decreasing and is consistent with the classical indicators.
Phase 4: During this phase, the trend in the indicators shows a stabilisation in the impulsivity of the signal, accompanied by a slight increase in energy. In fact, the stabilisation of the contrast and relevance of the outer race signature (parts A and C) indicates the presence of a pronounced and stable outer race signature, while the increase in contrast in the envelope shows that the energy of this signature is increasing slightly. This is in accordance with conventional indicators.
Phase 5: In this last phase, the vibratory energy generated by the defect (part B) increases rapidly until the bearing fails completely. This is manifested both by an increase in energy and by the impulsiveness of the signal. The increase in RMS and kurtosis, or

$$RMS = \sqrt{\frac{1}{N} {\sum }_{n = 1}^{N} {x [ n ]}^{2}} et Kurtosis = \frac{\frac{1}{N} {\sum }_{n = 1}^{N} {( x [ n ] - \tilde{x} [ n ] )}^{4}}{{RMS}^{4}} ,$$

confirms this. Similarly, the energy indicator of the outer race signature in the envelope spectrum (part B) undergoes an increase during this phase.

The three indicators, associated with each of the four types of defect, can be saved in a memory so that they can be interpreted by the ground operator, for example a maintenance technician, during an aircraft maintenance operation. After interpreting these diagnostic indicators, the operator is able to determine the state of damage to the bearing and therefore the health condition of the bearing. He is therefore able to decide whether or not the bearing should be changed.

As can be seen from the above, the method according to the invention is highly automated, with the operator only needing to interpret the diagnostic indicators obtained at the end of the process. In an alternative, the operator can also choose the values of the different parameters used in the method and described previously. In another alternative, the parameters are defined by default, as explained previously.

The method 100, which has just been described, can be integrated into an on-board monitoring system in an aircraft. It can also be integrated into any system for monitoring the vibration of a rotating system, such as a rotating machine or a combustion or explosion machine.

Although described through a number of examples, alternatives and embodiments, the method for detecting a bearing defect according to the invention includes various alternatives, modifications and improvements which will be obvious to the person skilled in the art, it being understood that these alternatives, modifications and improvements are within the scope of the invention.

1. A method for detecting a defect in a bearing of a rotating system, the method comprising:
a) acquiring a position signal of the bearing θ[n] with respect to a rotation shaft of the rotating system in which the bearing is mounted, a vibratory signal of the bearing x[n] and of a theoretical characteristic vector of the bearing V^{the}=[BPFO^{the}, BPFI^{the}, BSF^{the}, FTF^{the}, SRF] the theoretical characteristic vector of the bearing being determined from the geometric dimensions of said bearing;
b) determining a deterministic part of the vibratory signal and removing said deterministic part to obtain a residual signal r[n] which is a function of the position signal;
c) calculating, from the theoretical characteristic vector, lower V^{Low}=[BPFO^{Low}, BPFI^{Low}, BSF^{Low}, FTF^{Low}, SRF] and upper V^{Hi}=[BPFO^{Hi}, BPFI^{Hi}, BSF^{Hi}, FTF^{Hi}, SRF] bounds of defect frequencies;
a) calculating, from the vibratory signal, a spectral coherence γ₂ᵣ^{(fast)}(α, fₖ) and the square of the amplitude of the spectral coherence Γ₂ᵣ^{(fast)}(α, fₖ);
b) calculating, from the square of the amplitude of the spectral coherence and the lower and upper bounds of the defect frequencies, a current characteristic vector of the bearing V^{act}=[BPFO^{act}, BPFI^{act}, BSF^{act}, FTF^{act}, SRF];
c) determining a spectral cyclic contrast of defects as a function of spectral frequency E_{BPFO}(fₖ); E_{BPFI}(fₖ); E_{BSF}(fₖ); E_{FTF}(fₖ);
d) finely identifying signatures of interest lying in narrow frequency bands, by calculating an integrated weighted cyclic coherence associated with the defects [symbol] _{BPFO}(α); [symbol] _{BPFI}(α); [symbol] _{BSF}(α); [symbol] _{FTF}(α);
e) determining diagnostic indicators interpretable by an operator.

2. The method according to claim 1, wherein the defects include four types of defect, the defect frequencies and defect signatures being determined for each type of defect.

3. The method according to claim 2, wherein the four types of defect are: an outer race defect, an inner race defect, a rolling element defect and a cage defect.

4. The method according to claim 2, wherein step e) includes estimating, for each type of defect, a current defect frequency corresponding to the most probable frequency between the lower bound and the upper bound.

5. The method according to claim 2, wherein step f) includes, for each type of defect, determining a contrast of the signature of the defect and then applying this contrast to the square of the amplitude of the spectral coherence.

6. The method according to claim 2, wherein step g) includes, for each type of defect, determining a weight associated with said defect and then calculating a weighted integrated cyclic coherence for this defect.

7. The method according to claim 2, wherein the diagnostic indicators include, for each type of defect, a contrast of the signature of interest in the integrated weighted cyclic coherence. [symbol] _{BPFO}^{coh}; [symbol] _{BPFI}^{coh}; [symbol] _{BSF}^{coh}, [symbol] _{FTF}^{coh} a contrast of the signature of interest in an envelope spectrum of the residual signal [symbol] _{BPFO}^{env}; [symbol] _{BPFI}^{env}; [symbol] _{BSF}^{env}; [symbol] _{FTF}^{env} and a relevance indicator of the signature of interest [symbol] _{BPFO}^{coh}; [symbol] _{BPFI}^{coh}; [symbol] _{BSF}^{coh}; [symbol] _{FTF}^{coh}.

8. The method according to claim 2, wherein the diagnostic indicators are each quantified by means of a value, said value being close to zero in the absence of a defect.

9. The method according to claim 1, wherein step c) is carried out before step b), after step d) or simultaneously with step b) or d), the lower and upper bounds being input data for step e).

10. A system for monitoring the health condition of an aircraft by detecting a bearing defect, comprising a data processing device implementing the method according to claim 1.
